(19) United States
(12) Patent Application Publication
(10) Pub. No.: US 2021/0012286 A1
(43) Pub. Date: Jan. 14, 2021

(54) PACKAGE HANDLING CONTROL BASED ON CUSTOMER INPUT

(71) Applicant: Honda Motor Co., Ltd., Tokyo (JP)

(72) Inventor: Koo Ho SHIN, Huntington Beach, CA (US)

(21) Appl. No.: 16/507,879

(22) Filed: Jul. 10, 2019

(51) Int. Cl. G06Q 10/08; G05D 1/02

(52) U.S. Cl. CPC G06Q 10/08355; H04W 4/44; G05D 1/0212

(57) ABSTRACT

An electronic control device to provide package handling assistance for a vehicle. The electronic control device stores route information which includes a plurality of destination location points to be visited in an order by the vehicle, timing information, package handling instructions for at least one of a plurality of packages. The electronic control device transmits the route information to a plurality of information processing apparatuses related to a plurality of customers. The electronic control device receives a request from an information processing apparatus. The request includes a first destination location point from the plurality of destination location points for handling a package associated with a customer related to the information processing apparatus. The electronic control device updates the order of the plurality of destination location points based on the received request and further controls the movement of the vehicle based on the updated order.

### BACKGROUND

Typically, delivery or pickup of the packages may be performed either manually or through known automated systems. In both of these approaches, predefined paths may be followed to handle the packages with different customers in known locations. Certain conventional solutions may also consider change in locations of the customers and handle the packages based on the changed locations by modification of the predefined path. The modification of the path may cause utilization of extra resources (for example fuel, time) for the package handling systems which may further incur extra surcharge on the customer. The utilization of the extra resources and additional surcharge may not be desired either by the package handling systems or the customers. Thus, an advanced system may be desired which may manage real-time modifications in predefined package handling plans without the utilization of additional resources.

### SUMMARY

An electronic control device to provide package handling assistance for a vehicle is provided. The electronic control device may include a memory and circuitry coupled with the memory. The memory may be configured to store route information for each of a plurality of packages, wherein the route information may include a plurality of destination location points to be visited in an order by the vehicle, timing information associated with each of the plurality of destination location points, and package handling instructions for at least one of the plurality of packages at each of the plurality of destination location points. The circuitry may be configured to transmit the route information to a plurality of information processing apparatuses related to a plurality of customers associated with the plurality of packages. The circuitry may be further configured to receive a request from an information processing apparatus of the plurality of information processing apparatuses, wherein the request may indicate a first destination location point from the plurality of destination location points for handling a package associated with a customer which is related to the information processing apparatus. The circuitry may be further configured to update the order of the plurality of destination location points in the route information for handling the plurality of packages based on the received request. The circuitry may be further configured to control the movement of the vehicle based on the updated order of the plurality of destination location points in the route information for the plurality of packages.

A server to provide package handling assistance to vehicles is provided. The server may include a memory and circuitry coupled to the memory. The memory may be configured to store route information which indicates a plurality of routes for a plurality of vehicles, wherein each of the plurality of routes may indicate a plurality of destination location points to be visited in an order for handling a plurality of packages, timing information associated with each of the plurality of destination location points, and package handling instructions for at least one of the plurality of packages at each of the plurality of destination location points. The circuitry may be configured to transmit the stored route information to a plurality of information processing apparatuses related to a plurality of customers associated with the plurality of packages for each route. The circuitry may be further configured to receive a request from an information processing apparatus of the plurality of information processing apparatuses, wherein the request may indicate a first destination location point from the plurality of destination location points included in a route of the plurality of routes. The received request is for handling a package associated with a customer which is related to the information processing apparatus. The circuitry may be further configured to update the order of the plurality of destination location points of the route for handling the plurality of packages based on the received request. The circuitry may be further configured to transmit the updated order of the plurality of destination location points of the route to an electronic control device of a vehicle of the plurality of vehicles.

An information processing apparatus is provided that may include a display screen and circuitry. The circuitry may be coupled with the display screen. The display screen may be configured to display a graphical user interface (GUI). The circuitry may be configured to receive, from a server, route information of a vehicle for handling a plurality of packages, where the route information may include a plurality of destination location points to be visited in an order, timing information associated with each of the plurality of destination location points, and package handling instructions for at least one of the plurality of packages at each of the plurality of destination location points. The plurality of packages may include at least one package related to a customer associated with the information processing apparatus. The circuitry may be further configured to display, via the GUI, the received route information including the plurality of destination location points to be visited in the order, the associated timing information, and the package handling instructions. The circuitry may be further configured to receive, via the GUI, a user input to select a first destination location point from the plurality of destination location points for handling the at least one package related to the customer. The circuitry may be further configured to transmit the received user input indicating the selected first destination location point to the server. The circuitry may be further configured to receive an updated order of the plurality of destination location points, the associated timing information, and the package handling instructions for handling the plurality of packages from the server.

### BRIEF DESCRIPTION OF THE DRAWINGS

FIG. 1 is a block diagram that illustrates an exemplary network environment for an electronic control device to provide package handling assistance for a vehicle in accordance with an embodiment of the disclosure.

FIG. 2 is a block diagram that illustrates an exemplary electronic control device to provide package handling assistance to a vehicle in accordance with an embodiment of the disclosure.

FIG. 3 is a block diagram that illustrates an exemplary server to provide package handling assistance to vehicles in accordance with an embodiment of the disclosure.

FIG. 4 is a block diagram that illustrates an exemplary information processing device to receive package handling assistance from a server in accordance with an embodiment of the disclosure.

FIG. 5 illustrates an exemplary scenario to depict route information used to provide package handling assistance for a vehicle in accordance with an embodiment of the disclosure.

FIG. 6 illustrates an exemplary scenario to select a destination location point from a plurality of destination location points in route information by an information processing apparatus in accordance with an embodiment of the disclosure.

FIG. 7 depicts a flow chart that illustrates exemplary operations for an electronic control device to provide package handling assistance for a vehicle in accordance with an embodiment of the disclosure.

FIG. 8 depicts a flow chart that illustrates exemplary operations for a server to provide package handling assistance to vehicles in accordance with an embodiment of the disclosure.

FIG. 9 depicts a flow chart that illustrates exemplary operations for an information processing apparatus to receive package handling assistance from a server in accordance with an embodiment of the disclosure.

### DETAILED DESCRIPTION

Various embodiments of the present disclosure may be found in an electronic control device to provide package handling assistance for a vehicle (for example an autonomous or semi-autonomous vehicle). The electronic control device may be integrated or associated with the vehicle. The disclosed electronic control device may store route information for each of a plurality of packages to be handled (i.e. delivered or picked up) by the vehicle.

The route information may include a plurality of destination location points (for example address, geo-location, landmarks) to be visited in an order by the vehicle to handle the plurality of packages. The route information may further store timing information associated with each of the plurality of destination location points, and package handling instructions for at least one of the plurality of packages at each of the destination location points. The electronic control device may further transmit the route information to a plurality of information processing apparatus (for example mobile phone) associated with a plurality of customers to/from whom the plurality of packages have to delivered or picked up by the vehicle. The electronic control device may further receive a request from an information processing apparatus associated with a customer of the plurality of customers. The request may indicate the selection of one of the plurality of destination location points made by the customer on the information processing apparatus for early or late handling of the corresponding package.

The electronic control device may further update the order of the plurality of destination location points based on the received request without changing an original route of the vehicle set in the route information. The electronic control device may further control the movement of the vehicle based on the updated order of the plurality of destination location points to handle the plurality of packages. Thus, the disclosed electronic control device provides flexibility to customers to dynamically select one of the predefined location points of the route for early/late handling of corresponding packages, and further updates the order of the predefined location points based on the selection, without changing the actual route (or path) to be followed by the vehicle. This may further avoid any utilization of additional resources (for example fuel, time, cost) to be incurred by the vehicle to meet the customers requirement for early/late handling of the corresponding package, and also avoids any additional surcharge for the customers to make such requirements during or before handling of packages.

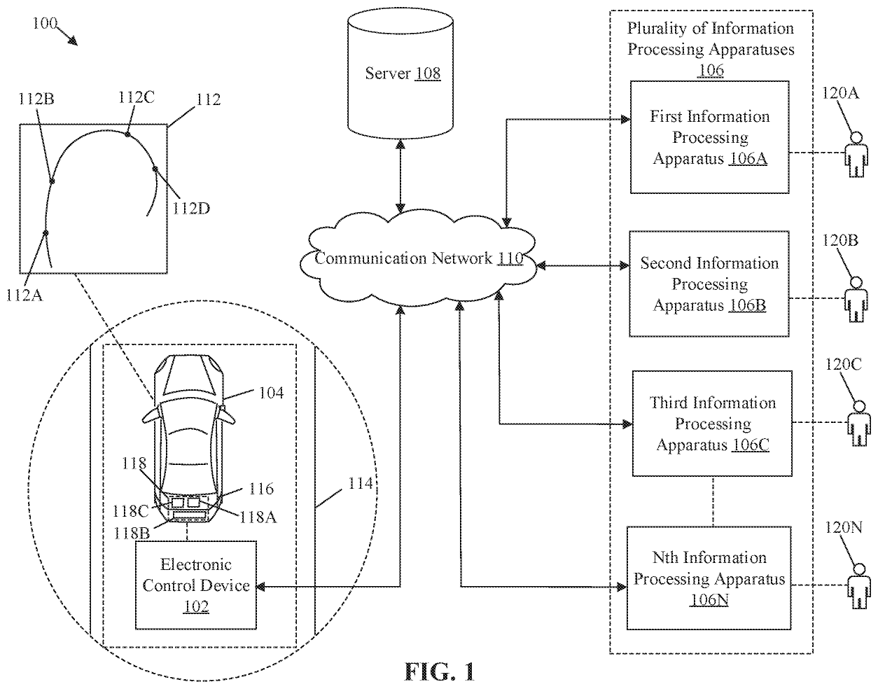

FIG. 1 is a block diagram that illustrates an exemplary network environment for an electronic control device to provide package handling assistance for a vehicle in accordance with an embodiment of the disclosure. With reference to FIG. 1, there is shown a network environment 100. The network environment 100 may include an electronic control device 102, a vehicle 104, a plurality of information processing apparatuses 106, a server 108, and a communication network 110. The vehicle 104 may be moving on a path or road 114. The vehicle 104 may include a trunk area 116 configured to store a plurality of packages 118.

The trunk area 116 may include a plurality of sections or compartments to store each of the plurality of packages 118. The plurality of information processing apparatuses 106 may be associated with a plurality of customers 120A-120N. The plurality of information processing apparatuses 106 may include a first information processing apparatus 106A associated with a first customer 120A. The first customer 120A may be a user to/from whom the delivery/pick-up of the corresponding package is to be done.

The first customer 120A may own or use the first information processing apparatus 106A to interact with the electronic control device 102, via the communication network 110. There is further shown a route 112 to be followed by the vehicle 104 for handling (delivery or pick-up) the packages 118 associated with the plurality of customers 120A-120N.

The route 112 may include a plurality of destination location points 112A-112D to be visited by the vehicle 104 in a predefined order based on geo-locations of the plurality of customers 120A-120N or the plurality of information processing apparatuses 106. A number of the plurality of destination location points 112A-112D shown in FIG. 1 is merely an example. The present disclosure may be applicable to any number of destination location points based on the number of packages for handling, without departing from the scope of the disclosure.

The electronic control device 102 may include suitable logic, circuitry, interfaces, and/or code that may be configured to provide package handling assistance for the vehicle 104. The electronic control device 102 may be a specialized electronic circuitry that may include an electronic control unit (ECU) processor to control different functions, such as, but not limited to, engine operations, communication operations, and data acquisition of the vehicle 104. The electronic control device 102 may control the vehicle 104 to handle (for example deliver or pick up) the packages 118 for the plurality of customers 120A-120N based on the predefined order of the route 112.

The electronic control device 102 may be configured to transmit the route information associated with the route 112 to the plurality of information processing apparatuses 106 via the communication network 110. The electronic control device 102 may be further configured to receive a request from a first information processing apparatus (for example the first Information processing apparatus 106A) of the plurality of information processing apparatuses 106 via the communication network 110. The request may indicate a first destination location point from the plurality of destination location points 112A-112D for the handling of a first package (for example a first package 118A) of the plurality of packages 118. The first package 118A may be associated with the first customer 120A associated with the first information processing apparatus 106A.

The electronic control device 102 may be further configured to update the predefined order of the plurality of destination location points for handling of the plurality of packages 118 based on the received request from the first customer 120A associated with the first information processing apparatus 106A. The electronic control device 102 may be further configured to control the movement of the vehicle 104 based on the updated order of the plurality of destination location points.

The electronic control device 102 may be a microprocessor. Other examples of the electronic control device 102 may include, but are not limited to, a vehicle control system, an in-vehicle infotainment (IVI) system, an in-car entertainment (ICE) system, an automotive Head-up Display (HUD), an automotive dashboard, an embedded device, a smartphone, a human-machine interface (HMI), a computer workstation, a handheld computer, a cellular/mobile phone, a portable consumer electronic (CE) device, a server, and other computing devices. The electronic control device 102 may be included or integrated in the vehicle 104.

The vehicle 104 may be a system configured to carry and deliver the plurality of packages 118 to the plurality of destination location points 112A-112D included in the route information. The vehicle 104 may be configured to pick up the plurality of packages 118 from the plurality of destination location points 112A-112D based on the customer request, for example, from the plurality of customers 120A-120N.

The vehicle 104 may be a semi-autonomous, or an autonomous vehicle. Examples of the vehicle 104 may include, but are not limited to, an electric vehicle, a hybrid vehicle, and/or a vehicle that uses a combination of one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. It may be noted that the vehicle 104 as shown in FIG. 1 is an example. The present disclosure may be also applicable to other types of vehicles, for example, truck, motorcycle, two-wheeler vehicles, three-wheeler vehicles, or the like.

The plurality of information processing apparatuses 106 may include suitable logic, circuitry, interfaces, and/or code that may be associated or owned by the plurality of customers 120A-120N. The plurality of customers 120A-120N may order or purchase the plurality of packages 118 through an online shopping application or website rendered on the plurality of information processing apparatuses 106. The plurality of information processing apparatuses 106 may be configured to receive the route information of a vehicle from the server 108.

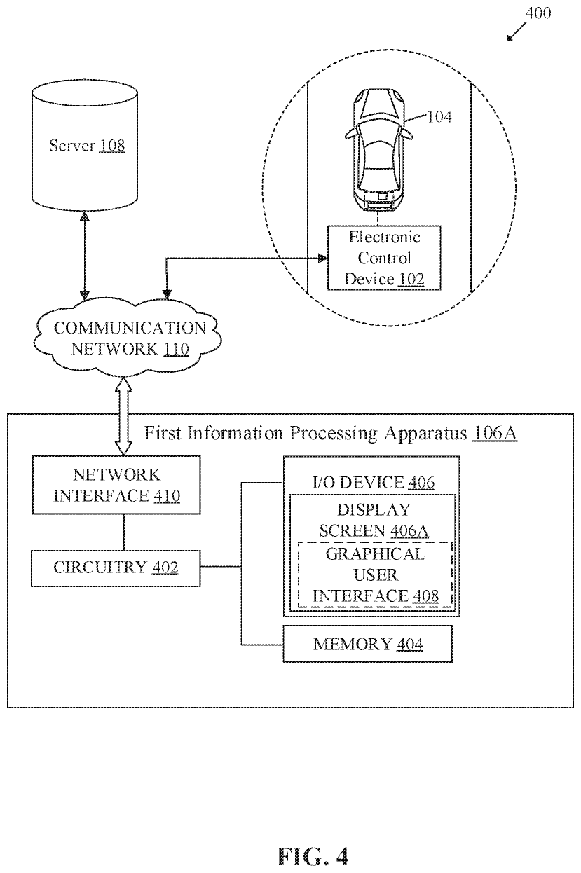

In some embodiments, the plurality of information processing apparatuses 106 may be configured to receive the route information from the electronic control device 102 of the vehicle 104. Each of the plurality of information processing apparatuses 106 may include a display screen (shown in FIG. 4). The display screen may be configured to display a graphical user interface (GUI).

Each of the plurality of the information processing apparatuses 106 may be further configured to display the received route information, via the GUI, to a corresponding customer associated with one of the plurality of the information processing apparatuses 106. Each of the plurality of information processing apparatuses 106 may be further configured to receive a customer input to select a first destination location point from the plurality of destination location points 112A-112D for handling of the plurality of packages 118.

The plurality of information processing apparatuses 106 may transmit the first destination location point to the server 108. In some embodiments, the first destination location point may be transmitted to the electronic control device 102 of the vehicle 104. Each of the plurality of information processing apparatuses 106 may be further configured to receive updated order of destination location points, associated timing information, and the package handling instructions. Examples of the plurality of information processing apparatuses 106 may include, but are not limited to a smartphone, a cellular/mobile phone, a personal digital assistance (PDA), a handheld computer, an audio-video (AV) entertainment device, a virtual-reality (VR) device, a computing device, a gaming device, and/or a consumer electronic (CE) device with wired/wireless communication capability.

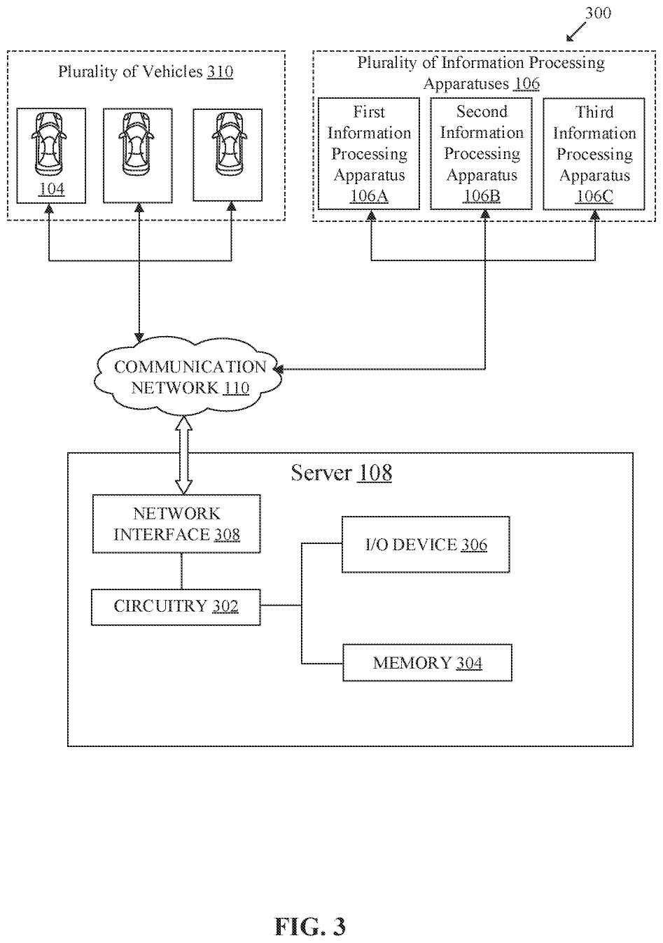

The server 108 may include suitable logic, circuitry, interfaces, and/or that may be configured to provide package handling assistance to a plurality of vehicles including the vehicle 104. The server 108 may be further configured to store the route information associated with the vehicle 104 or the plurality of vehicles (shown in FIG. 3). The server 108 may be configured to transmit the route information to the plurality of the information processing apparatuses 106 related to the plurality of customers (120A-120N) who are associated with the plurality of packages 118. The server 108 may be configured to assign a route 112 of the plurality of routes mentioned in the route information and the plurality of packages (for delivery or pick-up) to each of the plurality of vehicles.

The server 108 may be configured to communicate with each of the plurality of information processing apparatuses 106 and the vehicle 104, via the communication network 110. In some embodiments, the server 108 may be an online shopping server which may utilize autonomous or semi-autonomous vehicles for package handling. In some embodiments, the server 108 may be implemented as a cloud server, which may be utilized to execute various operations through web applications, cloud applications, HTTP requests, repository operations, file transfer, gaming operations, and the like. Examples of the server 108 may include, but are not limited to, an application server, a cloud server, a web server, a database server, a file server, a mainframe server, or a combination thereof.

The communication network 110 may include a communication medium through which the electronic control device 102, the plurality of information processing apparatuses 106, and the server 108 may communicate with each other. Examples of the communication network 110 may include, but are not limited to, Internet, a cloud network, a Long Term Evolution (LTE) network, a Wireless Local Area Network (WLAN), a Local Area Network (LAN), a telephone line (POTS), and/or a Metropolitan Area Network (MAN).

Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity (Li-Fi), 802.16, IEEE 802.11s, IEEE 802.11g, multi-hop communication, wireless access point (AP), device to device communication, cellular communication protocols, Bluetooth (BT) communication protocols, or a combination thereof.

In operation, the vehicle 104 may be assigned with a route (for example route 112) by the server 108 to deliver/pick-up the plurality of packages 118 to/from the plurality of customers 120A-120N. The plurality of packages 118 may be stored in the trunk area 116 of the vehicle 104. The electronic control device 102 of the vehicle 104 may be configured to receive, from the server 108, the route information which may indicate the route 112.

The route information may include information related to the destination location points 112A-112D to be visited by the vehicle 104 in an order, timing information associated with the destination location points to deliver or pick up the plurality of packages 118, and the package handling instructions for the plurality of packages 118. The destination location points 112A-112D may be geo-locations where the packages are to be delivered to or picked up from the plurality of customers 120A-120N. In some embodiments, the destination location points 112A-112D may be, but are not limited to, postal address, landmarks, point of interest (POI), or popular palaces to/from which the vehicle 104 can deliver or pick up the plurality of packages 118. The timing information may indicate exact time at which the plurality of packages 118 are to be delivered or picked up to/from the plurality of customers 120A-120N.

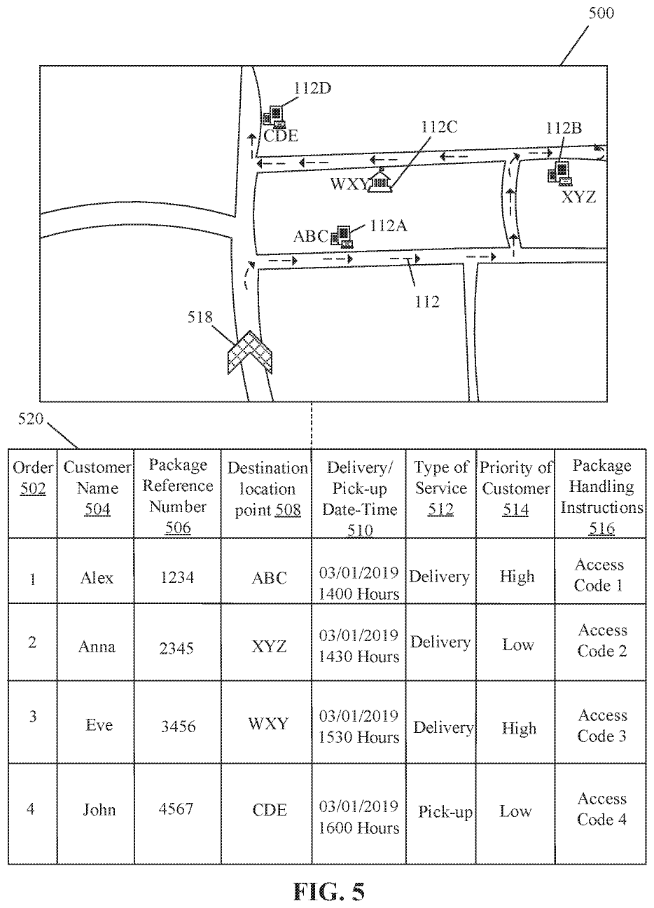

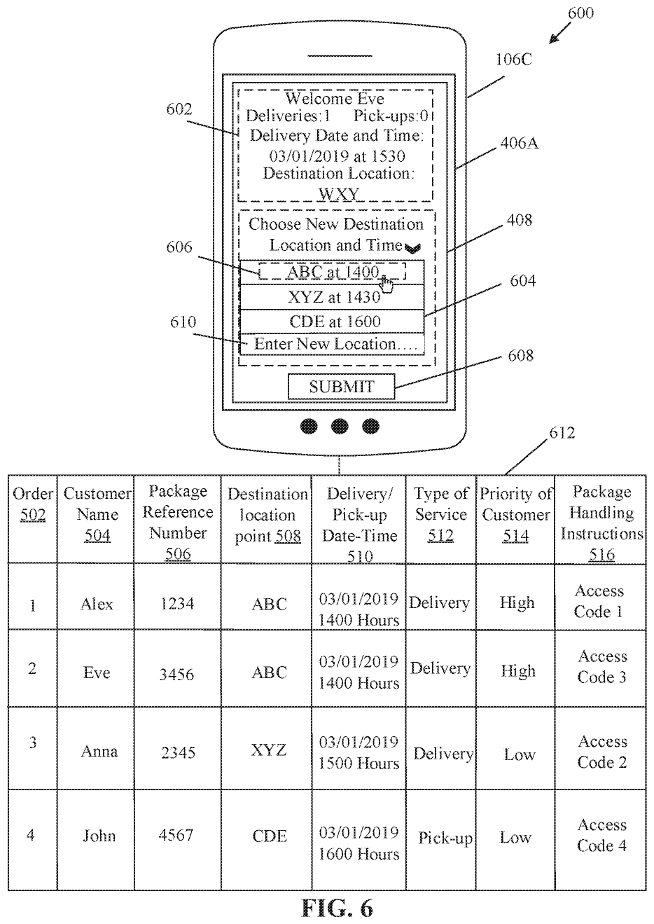

The package handling instructions may indicate certain instruction or information (for example related to authentication) which have to be followed either by the electronic control device 102 or by the plurality of customers 120A-120N during the package handling (delivery or pickup). Further details of the route information may be described in detail, for example, in FIGS. 5 and 6.

The electronic control device 102 may be configured to store the received route information in a memory (not shown) associated with the electronic control device 102. The electronic control device 102 may be further configured to transmit the received route information, via the communication network 110, to the plurality of information processing apparatuses 106 related to the plurality of customers 120A-120N associated with the plurality of packages 118. The electronic control device 102 may be further configured to receive a request from an information processing apparatus (for example the first information processing apparatus 106A) of the plurality of information processing apparatuses 106 to change a first destination location point for handling of a first package 118A associated with the first customer 120A who is related to the first information processing apparatus 106A.

The first destination location point may be included in the plurality of destination location points 112A-112D of the received route information. The plurality of destination location points 112A-112D may include a second destination location point to which the first package 118A has to be originally delivered or picked up. Thus, the received request may indicate the change from the second destination location point to the first destination location point. The first and the second destination location points are present in the plurality of destination location points of the route information to be visited by the vehicle 104. The first destination location point may be before the second destination location point and the request may be received prior to the vehicle 104 reaching the second destination location.

The first destination location point may be selected by the first customer 120A from the plurality of destination location points 112A-112D which may be rendered on a display screen (not shown) of the first information processing apparatus 106A associated with the first customer 120A. Details of the selection of the first destination location point from the plurality of destination location points 112A-112D in the route information may be described in detail, for example, in FIG. 6.

The electronic control device 102 may be further configured to update the order of the destination location points 112A-112D in the route information based on the received request (which indicates the first destination location point) without a change in the route to be followed by the vehicle 104. The process of updating the route information may also include updating the timing or the package handling instructions associated with each of the destination location points 112A-112D. The process of updating the order of the plurality of destination location points may be described in detail, for example, in FIG. 6.

The electronic control device 102 may be configured to transmit the updated order of the plurality of destination location points 112A-112D in the route information to the first information processing apparatus 106A, via the communication network 110. The electronic control device 102 may be configured to control the movement of the vehicle 104 based on the updated order of destination location points 112A-112D in the route information to handle the plurality of packages 118. The control of the movement of vehicle 104 may correspond to the navigation of the vehicle 104 to the plurality of destination location points 112A-112D according to the updated order of the plurality of destination location points 112A-112D in the route information. Thus, the disclosed electronic control device 102 provides real-time receipt of requests from the customers to change the delivery or pick-up location point amongst the plurality of location points of the route.

The electronic control device 102 may further change the order of the plurality of location points based on the received customer request without re-routing the route 112. Thus, no additional resources (for example fuel, time, cost) are utilized by the vehicle 104 to handle the associated package based on the received request. This in turn does not incur an additional surcharge on the customer who provides the request to change the destination location point for the handling of their one or more packages, or alternatively may incur a smaller surcharge than for a more costly change. In some embodiments, the electronic control device 102 may correspond to a server and the operations performed by the electronic control device 102 may be performed by the server.

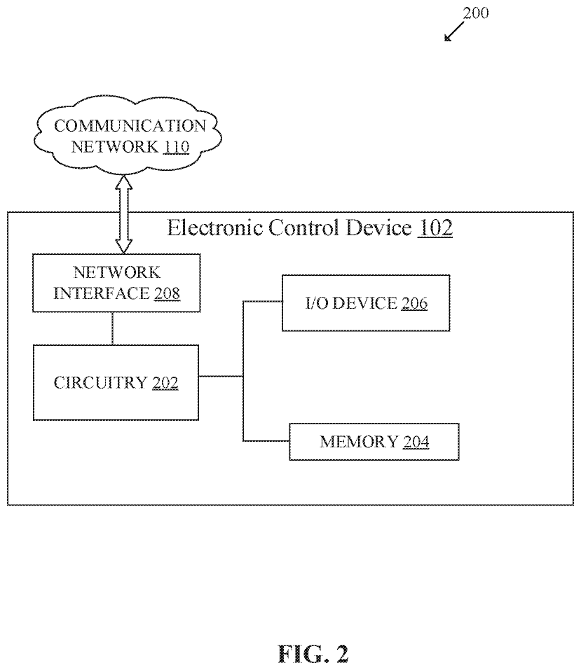

FIG. 2 is a block diagram that illustrates an exemplary electronic control device to provide package handling assistance for a vehicle in accordance with an embodiment of the disclosure. With reference to FIG. 2, there is shown the electronic control device 102. The electronic control device 102 may include circuitry 202, a memory 204, an I/O device 206, and a network interface 208. The circuitry 202 may be connected with the memory 204, the I/O device 206, and the network interface 208 through wired or wireless connections. The electronic control device 102 may be associated with the vehicle 104. In some embodiments, the electronic control device 102 may be integrated into the vehicle 104.

The circuitry 202 may include suitable logic, circuitry, interfaces, and/or code that may be configured to execute a set of instructions stored in the memory 204. The circuitry 202 may be configured to control the memory 204, the I/O device 206, and the network interface 208 to perform different operations based on the set of instructions. The circuitry 202 may be configured to control different operations of the vehicle 104 based on the execution of the set of instructions. The circuitry 202 may be configured to receive the route information from the memory 204. In some embodiments, the circuitry 202 may be configured to receive the route information from the server 108, via the communication network 110. The circuitry 202 may be configured to transmit the route information to the plurality of information processing apparatuses 106 related to the plurality of customers 120A-120N which are associated with the plurality of packages 118 to be handled in the predefined order mentioned in the route information.

The circuitry 202 may be configured to receive the request from the first information processing apparatus 106A of the plurality of Information processing apparatuses 106, via the network interface 208 as described in FIG. 1. The circuitry 202 may be further configured to update the order of plurality of destination location points 112A-112D in the route information for handling of the plurality of packages 118 based on the received request. The circuitry 202 may be further configured to control the movement of the vehicle 104 based on the updated order of the plurality of destination location points in the route information for handling of the plurality of packages 118. The circuitry 202 may be implemented based on a number of processor technologies known in the art. Examples of the circuitry 202 may include a Graphical Processing Unit (GPU), a Central Processing Unit (CPU), an x86-based processor, an x64-based processor, a Reduced Instruction Set Computing (RISC) processor, an Application-Specific Integrated Circuit (ASIC) processor, a Complex Instruction Set Computing (CISC) processor, and/or other hardware processors.

The memory 204 may include suitable logic, circuitry, interfaces, and/or code that may be configured to store a set of instructions executable by the circuitry 202. The memory 204 may store the route information for the vehicle 104. The memory 204 may also store the updated order of the plurality of destination location points 112A-112D in the route information. The memory 204 may also store information related to the plurality of packages 118 to be delivered or picked up to/from the plurality of customers 120A-120N on the route 112. The memory 204 may store information related to the plurality of customers 120A-120N. Examples of implementation of the memory 204 may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive one or more inputs from occupants of the vehicle 104. The I/O device 206 may also be configured to display outputs (for example the route information) to the occupants of the vehicle 104. The I/O device 206 may further be configured to provide the one or more user inputs to the circuitry 202 to further control the plurality of operations of the electronic control device 102 or the vehicle 104. The I/O device 206 may be further configured to receive outputs from the circuitry 202 to be displayed. Examples of the one or more user inputs may include, but are not limited to, a voice input, a gesture input, a touch input, and a text input. Examples of the I/O device 206 may include, but are not limited to, a touchscreen interface, a touch pad, a keyboard, a microphone, a camera, a computer mouse, a display, and a speaker.

The network interface 208 may include suitable logic, circuitry, interfaces, and/or code that may be configured to enable communication between the circuitry 202 and the server 108 or the plurality of information processing apparatuses 106 via the communication network 110. The network interface 208 may implement by use of various known technologies to support wired or wireless communication of the electronic control device 102 with the communication network 110. The network interface 208 may include, but is not limited to, an antenna, a frequency modulation (FM) transceiver, a radio frequency (RF) transceiver, one or more amplifiers, a tuner, one or more oscillators, a digital signal processor, a coder-decoder (CODEC) chipset, a subscriber identity module (SIM) card, and/or a local buffer. The electronic control device 102 may include another component as well to perform different functions of the electronic control device 102.

FIG. 3 is a block diagram that illustrates an exemplary server to provide package handling assistance to vehicles in accordance with an embodiment of the disclosure. With reference to FIG. 3, there is shown the server 108. The server 108 may include circuitry 302, a memory 304, an input-output (I/O) device 306, and a network interface 308. The circuitry 302 may be connected with the memory 304, the I/O device 306, and the network interface 308 through wired or wireless connections.

There is also shown a plurality of vehicles 310 and the plurality of information processing apparatuses 106. The plurality of vehicles 310 may include the vehicle 104 shown in FIG. 1. The function of each of the vehicles 310 may be similar to the function of the vehicle 104 shown in FIG. 1. The circuitry 302 of the server 108 may communicate with the electronic control device 102 of the plurality of vehicles 310 and the plurality of information processing apparatuses 106, through the communication network 110 and the network interface 308.

The circuitry 302 may include suitable logic, circuitry, interfaces, and/or code that may be configured to execute a set of instructions stored in the memory 304. The circuitry 302 may be configured to control the memory 304, the I/O device 306, and the network interface 308 to perform different operations based on the set of instructions. The circuitry 302 may be configured to receive the route information from the memory 304. The route information may indicate a plurality of routes for the plurality of vehicles 310.

Each of the plurality of routes may indicate a plurality of destination location points to be visited in an order for handling of a plurality of packages. The route information may further indicate timing information associated with each of the plurality of destination location points, and the package handling instructions for at least one of the plurality of packages. The circuitry 302 may be configured to transmit the route information to the plurality of information processing apparatuses 106 related to the plurality of customers 120A-120N who are associated with the plurality of packages 118 for each route via the communication network 110.

The circuitry 302 may be configured to receive a request from the first information processing apparatus 106A of the plurality of information processing apparatuses 106 via the network interface 308. The request may indicate the first destination location point from the plurality of destination location points included in the route (for example the route 112) of the plurality of routes. The route 112 may be associated with a vehicle 104 of the plurality of vehicles 310. The circuitry 302 may be further configured to update the order of the plurality of destination locations in the route information of the route for handling the plurality of packages 118 based on the received request.

The circuitry 302 may be further configured to transmit the updated order of the route to the electronic control device 102 of the vehicle 104 of the plurality of vehicles 310 via the communication network 110. The circuitry may also be configured to select a vehicle (for example the vehicle 104) from the plurality of vehicles 310 based on the geo-location of the vehicle and the geo-locations of the destination location points of the route for handling of the plurality of packages 118.

The circuitry 302 may be configured to analyze a number of the plurality of destination location points and a number of the plurality of packages 118 for the plurality of routes and assign a set of plurality of destination location points and a set of packages to each of the plurality of vehicles 310 based on the analysis. The details of the selection of the vehicle and assignment of the routes are described in detail, for example, in FIG. 6.

The circuitry 302 may be implemented based on a number of processor technologies known in the art. Examples of the circuitry 302 may include a Graphical Processing Unit (GPU), a Central Processing Unit (CPU), an x86-based processor, an x64-based processor, a Reduced Instruction Set Computing (RISC) processor, an Application-Specific Integrated Circuit (ASIC) processor, a Complex Instruction Set Computing (CISC) processor, and/or other hardware processors.

The memory 304 may include suitable logic, circuitry, interfaces, and/or code that may be configured to store a set of instructions executable by the circuitry 302. The memory 304 may store the route information for each of the plurality of routes to be travelled by the plurality of vehicles 310. The memory 304 may also store the updated order of the plurality of destination location points in the route information for the plurality of routes. The memory 304 may also store information related to the plurality of packages 118 to be delivered or picked up to/from the plurality of customers 120A-120N on the plurality of routes. The memory 304 may store information related to plurality of customers 120A-120N from whom the plurality of packages 118 are to be picked and to whom the plurality of packages 118 are to be delivered for each route. Examples of implementation of the memory 304 may be similar to the memory 204 as described in FIG. 2.

The functions of the I/O device 306 and the network interface 308 may be the same as the functions of the I/O device 206 and the network interface 208 of FIG. 2. The server 108 may include other components as well to perform different functions of the server 108.

In operations, the server 108 may store the route information for each of the plurality of vehicles 310 and may be configured to transmit the stored route information to the plurality of information processing apparatuses 106 related to the plurality of customers 120A-120N for each route of the plurality of routes. Each route of the plurality of routes may be associated with one of the plurality of vehicles 310. The server 108 may be further configured to receive a request, related to handling (i.e. delivery or pick-up) of a first package 118A, from a first information processing apparatus 106A which is related to the first customer 120A.

The first package 118A and the first customer 120A may be associated with a route of the plurality of routes. The request may indicate a first destination location point from the plurality of destination location points of the route. In response to the request, the server 108 may be configured to update the order of the plurality of destination location points and transfer the updated order to the electronic control device 102 of the vehicle 104 so that the movement of the vehicle may be controlled according to the updated order of plurality of destination location points.

FIG. 4 is a block diagram that illustrates an exemplary information processing apparatus to receive package handling assistance from a server in accordance with an embodiment of the disclosure. With reference to FIG. 4, there is shown a first information processing apparatus 106A of the plurality of information processing apparatuses 106. The first information processing apparatus 106A may include circuitry 402, a memory 404 and an input/output (I/O) device 406. The I/O device 406 may include a display screen 406A which may render a Graphical User Interface (GUI) 408. The first information processing apparatus 106A may further include a network interface 410. The circuitry 402 may be connected with the memory 404, the I/O device 406, and the network interface 410 through wired or wireless connections. The first information processing apparatus 106A may communicate with the server 108 and/or the electronic control device 102 of the vehicle 104 via the network interface 410 and the communication network 110 as shown in FIG. 4.

The circuitry 402 may include suitable logic, circuitry, interfaces, and/or code that may be configured to execute a set of instructions stored in the memory 404. The circuitry 402 may be configured to control the memory 404, the I/O device 406, and the network interface 410 to perform different operations based on the set of instructions. The circuitry 402 may be configured to receive the route information from the server 108 via the network interface 410. In some embodiments, the circuitry 402 may be configured to receive the route information from the electronic control device 102 of the vehicle 104 via the network interface 410.

The circuitry 402 may be configured to display the received route information via the graphical user interface (GUI) 408 on the display screen 406A. The route information may include a plurality of destination location points to be visited by the vehicle 104, the timing information, and the package handling instructions for packages associated with the destination location points. The plurality of destination location points may include the second destination location point to which the first package 118 has to be actually delivered or picked up from the first customer 120A (shown in FIG. 1) associated with the first information processing apparatus 106A.

The circuitry 402 may be further configured to receive a user input via the GUI 408 from the first customer 120A. The user input may correspond to selection of a first destination location point from the plurality of destination location points for early or late handling of a first package 118A associated with the first customer 120A. The first destination location point selected by the first customer 120A may be an earlier or later delivery or pick-up point than the second destination location point originally set in the route information. The details of the selection are described in detail, for example, in FIG. 6.

The circuitry 402 may be further configured to transmit the received user input indicating the selection of the first destination location point to the server 108 via the network interface 410. In some embodiments, the circuitry 402 may be further configured to transmit the received user input indicating the selection of the first destination location point to the electronic control device 102 of the vehicle 104.

The circuitry 402 may be further configured to receive the updated order of the plurality of destination location points from the server 108. In some embodiments, the circuitry 402 may be further configured to receive the updated order of the plurality of destination location points from the electronic control device 102 via the network interface 410. The circuitry 402 may be implemented based on a number of processor technologies known in the art. Examples of the circuitry 402 may include a Graphical Processing Unit (GPU), a Central Processing Unit (CPU), an x86-based processor, an x64-based processor, a Reduced Instruction Set Computing (RISC) processor, an Application-Specific Integrated Circuit (ASIC) processor, a Complex Instruction Set Computing (CISC) processor, and/or other hardware processors.

The memory 404 may include suitable logic, circuitry, interfaces, and/or code that may be configured to store a set of instructions executable by the circuitry 402. The memory 404 may store the route information for the vehicle 104 which may need to deliver the first package 118A to the first customer 120A associated with the first information processing apparatus 106A. The memory 404 may also store customer information that may be desired to verify the first customer 120A for the handling of plurality of packages 118 during delivery or pick-up. The memory 404 may also store information related to at least the first package 118A associated with the first customer 120A or to be picked up from the first customer 120A of the plurality of customers. Examples of implementation of the memory 404 may be similar to the memory 204 and the memory 304 as described in FIGS. 3 and 4.

The I/O device 306 may include suitable logic, circuitry, interfaces, and/or code that may be configured to receive one or more inputs (for example user inputs to select the destination location point) from the first customer 120A and display the route information of the vehicle 104) to the first customer 120A related to the first information processing apparatus 106A. The I/O device 306 may include a display screen 406A.

The display screen 406A may include suitable logic, circuitry, and interfaces that may be configured to display, via the GUI 408, the route information to the first customer 120A related to the first information processing apparatus 106A. The details of the displayed route information may be described in detail, for example, in FIGS. 5 and 6. In some embodiments, the display screen 406A may be an external display screen associated with the first information processing apparatus 106A. The display screen 406A may be a touch screen which may enable a user, such as the first customer 120A, to provide a user-input via the display screen 406A.

The touch screen may be at least one of a resistive touch screen, a capacitive touch screen, or a thermal touch screen. The display screen 406A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display screen 406A may refer to a display screen of a head mounted device (HMD), a smart-glass device, a see-through display, a projection-based display, an electro-chromic display, or a transparent display.

The first information processing apparatus 106A may include other components as well to perform different functions of the first information processing apparatus 106A. The function of the network interface 410 may be same as the function of the network interface 208 and the network interface 308 of FIGS. 2 and 3.

FIG. 5 illustrates an exemplary scenario to depict route information used to provide package handling assistance for a vehicle in accordance with an embodiment of the disclosure. With reference to FIG. 5, there is shown a roadmap 500. The roadmap 500 may indicate the route 112 (i.e. path indicated by dotted arrows) that may be followed by a vehicle (for example the vehicle 104) to deliver/pick-up the plurality of packages 118 to/from the plurality of the customers 120A-120N. The route 112 may be indicated by the route information stored in the memory 204 of the electronic control device 102. In some embodiments, the roadmap 500 may be displayed on a display screen of the vehicle or the display screen 406A of the first information processing apparatus 106A.

The route 112 may include the plurality of the destination location points 112A-112D to be visited in an order by the vehicle 104 for handling the plurality of packages 118. For example, in FIG. 5, the route 112 may include a first destination location point 112A (also referred to as “ABC”), a second destination location point 112B (also referred to as “XYZ”), a third destination location point 112C (also referred to as “WXY”), and a fourth destination location point 112D (also referred to as “CDE”) to be visited in the same order.

Examples of the plurality of destination location points 112A-112D may include, but are not limited to, postal address, landmarks, point of interest (POI), or popular places to/from which the vehicle 104 can deliver or pick up the plurality of packages 118. In some embodiments, the roadmap 500 may be displayed on each of the plurality of information processing apparatuses 106. A current geo-location 518 of the vehicle 104 may also be displayed to each of the plurality of information processing apparatuses 106 as shown in FIG. 5.

In some embodiments, the displayed current geo-location 518 of the vehicle 104 may be received from the electronic control device 102. The current geo-location 518 of the vehicle 104 may be useful for the plurality of customers 120A-120N to track the vehicle 104 during the route 112 for handling of the corresponding packages.

In FIG. 5, there is further shown a first table 520 that may indicate the route information. The route information may include information such as, but is not limited to, order 502, customer name 504, package reference number 506, destination location point 508, delivery/pick-up date and time 510, type of service 512, priority of customer 514, and package handling instructions 516. The information shown in the first table 520 is merely an example. However, the route information may include additional information, without departure from the scope of the disclosure.

The order 502 may correspond to the order in which each of the plurality of the packages 118 have to be delivered or picked up to/from the associated customers. In some embodiments, the order 502 may also refer to an order in which the vehicle 104 will reach at each of the plurality of the destination location points 112A-112D indicated by the route 112.

The customer name 504 may correspond to names of the plurality of customers 120A-120N with whom the corresponding packages have to handled. In some embodiments, the customer name 504 may also indicate other identification information related to the plurality of customers 120A-120N. The identification information may include, but is not limited to, an e-mail address, a unique access code (that may be sent by the server 108 or online shopping website), biometric data, data related facial characteristics, a phone number, a subscriber identity number. The customer name 504 may be used by the vehicle 104 (for example autonomous vehicle) or the electronic control device 102 to automatically interact with the plurality of customers 120A-120N or the plurality of information processing apparatuses 106 while delivering or picking the corresponding packages.

The package reference number 506 may correspond to a number that uniquely identifies each of the plurality of packages 118 to be handled during the route 112 with respect to each customer indicated by the customer name 504. The numerals mentioned for the package reference number 506 in FIG. 5 is merely an example. However, the package reference number 506 may be represented by different alphanumeric characters, without departing from the scope of the disclosure.

The destination location point 508 may correspond to the geo-locations from where the packages are to be picked up or to be delivered. Examples of the destination location point 508 may include, but are not limited to, a landmark, a postal address, a popular place, a building, a package warehouse, customer's house, customer's office or a particular desired location set by the customer during the shopping. In some embodiments, the destination location point 508 may correspond to geo-coordinates.

The delivery/pick-up date and time 510 may correspond to the time at which the plurality of packages have to be delivered or picked up to/from the corresponding customer. The time may be expressed in 24-Hours or 12-Hours format. In some embodiments, the delivery/pick-up date and time 510 may be same for multiple packages in case the destination location points for those packages are same or within a certain permissible range (for example within 100 meters).

The type of service 512 may correspond to delivery service or pick-up service or a combination of both for handling of the packages. For example, the delivery service may indicate that one or more packages have to be delivered to the first customer 120A at the corresponding destination location point. The pick-up service may indicate that the one or more packages have to be picked up from the customer at the corresponding destination location point.

The priority of customer 514 may correspond to a priority which may be related to a particular customer for handling corresponding package. The priority may be set by the customer while ordering the package. The priority of customer 514 may have a wide range of values. For the sake of simplicity, the priority of customer 514 is shown as either of “High” or “Low” in the first table 520. A value of “High” may indicate that the corresponding package must be delivered or picked up on a priority basis without a delay with respect to the set delivery/pick-up time 510. For example, a delivery/pick-up date and time 510 for a customer with “High” priority should not be delayed even the order of the handling of packages are updated based on the request received from different customers.

The package handling instructions 516 may indicate different instructions or information to be referred by the electronic control device 102, the plurality of information processing apparatuses 106, or the plurality of customers 120A-120N at the time of delivery or pick-up of the corresponding package. For example, the package handling instructions 516 may indicate authentication information associated with the corresponding customer or the associated information processing apparatus.

The authentication information may be used by the electronic control device 102 of the vehicle 104 to verify the authenticity of each of the plurality of customers 120A-120N before delivering or picking the corresponding package. For example, a first customer 120A may need to enter an authenticated access code on the display screen associated with the electronic control device 102 or the vehicle 104 to receive the associated first package 118A from the trunk area 116 of the vehicle 104.

The authentication information indicated by the package handling instructions 516 may include such authenticated access codes to authenticate the first customer 120A. The authentication access code is merely an example. However, the package handling instructions 516 may include, but is not limited to, facial characteristics, voice sample, or biometric data to authenticate the corresponding customers. In some embodiments, the package handling instructions 516 may provide exact location near the set destination location point, where the corresponding package will be delivered or placed. For example, the package handling instructions 516 may indicate that the package will be delivered near the lamp post placed at the location mentioned by the destination location point 508 in the first table 520

As examples of the route information shown in FIG. 5, “Alex” is the first customer 120A to receive a first package with reference number “1234” at 1400 hours at “ABC” location. “Anna” is a second customer 120B to whom a second package with reference number “2345” has to be delivered at 1430 hours at “XYZ” location. Further, “Eve” is a third customer 120C to whom a third package with reference number “3456” has to be delivered at 1530 hours at “WXY” location. Further, a last package with package reference number “4567” will be picked up from a fourth customer “John” at 1600 hours at “CDE” location.

FIG. 6 illustrates an exemplary scenario to select a destination location point from a plurality of destination location points in route information by an information processing apparatus in accordance with an embodiment of the disclosure. With reference to FIG. 6, there is shown an information processing apparatus (for example one of the plurality of information processing apparatuses 106 shown in FIG. 1). The information processing apparatus may be associated with a customer (for example one of the plurality of customers 120A-120N) to whom a package has to be delivered or picked up.

With reference to the example of the route information mentioned in FIG. 5, the information processing apparatus has been considered as a third information processing apparatus 106C in FIG. 6. Similarly, the customer has been referred as the third customer 120C (“Eve”) and the package to be delivered to the third customer 120C has been referred as the third package 118C, hereinafter, in FIG. 6. The functions of the third customer 120C may be similar to functions of the first information processing apparatus 106A shown in FIGS. 1 and 4.

In FIG. 6, there is further shown the display screen 406A and the GUI 408 of the third information processing apparatus 106C. The third information processing apparatus 106C may be configured to receive the route information associated with the third package 118C from the electronic control device 102 of the vehicle 104 or the server 108. The circuitry 402 of the third information processing apparatus 106C associated with the third customer 120C may be configured to extract information 602 corresponding to the third package 118C from the received route information and display the extracted information 602 on the display screen 406A via the GUI 408.

The GUI 408 of the display screen 406A may display the extracted information 602 (such as delivery/pick-up date and time 510 and destination location point 508) for the third package 118C. For example, “03/03/19 at 1530 hours” and “WXY” has been shown in FIG. 6 as the delivery/pick-up date and time 510 and the destination location point 508 for the third customer 120C (“Eve”). The displayed destination location point 508 and the delivery/pick-up date and time 510 may indicate the original destination location point and the associated time information at which the third package 118C has to be delivered to the third customer 120C as per the received route information. The displayed destination location point 508 and the delivery/pick-up date and time 510 as the extracted information 602 shown in FIG. 6 is merely an example. However, the display screen 406A may display other data from the route information described, for example, in FIG. 5. In some embodiments, the display screen 406A may conceal the authentication information included in the package handling instructions 516 for security purposes.

In FIG. 6, there is also shown a list 604 displayed on the GUI. The list 604 may include information related to details of all the packages included in the route information received by the third information processing apparatus 106C. In some embodiments, the list 604 may include the destination location point 508 and the delivery/pick-up date and time 510 of all the plurality of packages 118 mentioned in the received route information. As shown in FIG. 6, the list 604 indicates the destination location point 508 and the delivery/pick-up date and time 510 of the first customer 120A, the second customer 120B, and the fourth customer 120D as “ABC at 1400 hours”, “XYZ at 1430 hours”, and “CDE at 1600 hours”. The destination location point 508 and the delivery/pick-up date and time 510 associated with the third package 118C may not be indicated by the list 604 as indicated by the extracted information 602.

In accordance with an embodiment, the circuitry 402 of the third information processing apparatus 106C may be further configured to receive, via the GUI 408 or the I/O device 406, a user input from the third customer 120C. The user input may be a selection 606 of a destination location point from the plurality of destination location points displayed on the GUI 408. For example, the user input provided by the third customer 120C may be the selection 606 of the first destination location point 112A (i.e. associated with the first customer 120A) indicated in the list 604.

As shown in FIG. 6, the selection 606 is a selection of “ABC” as the first destination location point 112A of the first customer 120A. The first destination location point 112A (also referred to as “ABC”) is earlier than the third destination location point 112C (also referred to as “WXY”) associated with the third customer 120C in the route information. The selection 606 may indicate that the third customer 120C may want to get the third package 118C to be delivered or handled at the first destination location point 112A which is one of the plurality of destination location points 112A-112D already set in the route information. In another embodiment, the selection 606 may be a selection of a fourth destination location point 112D (also referred to as “CDE”) which may be later than the third destination location point 112C (also referred to as “WXY”) associated with the third customer 120C in the route information.

The circuitry 402 of the third information processing apparatus 106C may be further configured to transmit the received user input (i.e. selection 606 of the first destination location point 112A) as a request to the electronic control device 102 of the vehicle 104. The circuitry 402 may transmit the request to the electronic control device 102 based on a selection of the GUI option 608 (“Submit” shown in FIG. 6) by the third customer 120C. In some embodiments, the circuitry 402 may transmit the received user input to the server 108. Further, the circuitry 202 of the electronic control device 102 may receive the request and verify whether the received request indicating the first destination location point 112A is one of the plurality of destination location points 112A-112D set in the route information of the vehicle 104.

In the case that the selected first destination location point 112A is included in the route information, the circuitry 202 may be configured to accept the received request. Similarly, the circuitry 302 of the server 108 may perform the same processing of verification and acceptance of the received user input with respect to the route information set for the vehicle 104 from the plurality of vehicles 310. The circuitry 202 of the electronic control device 102 or the circuitry 302 of the server 108 may perform the verification of the received user input to ensure that the vehicle 104 should not change the route 112 and avoid an extra utilization of resources (like fuel, time, or cost) at the end of the vehicle 104 to satisfy the user input to change the delivery/pick-up location originally set for the third package 118C for the third customer 120C.

In FIG. 6, there is further shown a GUI option 610 (for example a textbox), through which the circuitry 402 may receive a new destination location point as the user input from the third customer 120C. The new destination location point may be a location which is not included in the plurality of destination location points 112A-112D in the route information. The circuitry 402 of the third information processing apparatus 106C may be further configured to transmit the received user input indicating the new destination location point as the request to the electronic control device 102 or the server 108.

The circuitry 202 of the electronic control device 102 may receive the user input indicating the new destination location point. The circuitry 202 may be configured to determine whether the new destination location point is different from each of the plurality of destination location points 112A-112D or not. If the new destination location point is different, the circuitry 202 may determine whether a distance between the new destination location point and each of the plurality of destination location points 112A-112D is within a threshold distance (for example 100 meters) or not. If not, the circuitry 202 may discard the received request indicating the new destination location point, considering the vehicle 104 may change the route 112 which may require extra resources (like fuel, time, cost) for the vehicle 104 to handle the package at the new destination location point.

If the new destination location point is within the threshold distance (for example 100 meters) of the first destination location point 112A (“ABC”), the circuitry 202 may select or accept the first destination location point 112A from the plurality of destination location points 112A-112D as the early delivery location point for the third customer 120C. With the selection of the first destination location point 112A, the circuitry 202 may not change the route 112 for the vehicle 104 which also does not incur an additional resource (like fuel, time, cost) for the vehicle 104. Thus, there is no additional cost for the vehicle 104 to satisfy the request received from the customer to change the delivery/pick-up location.

Based on the acceptance of the received request (either indicating the first destination location point or the new destination location point), the circuitry 202 of the electronic control device 102 may update the route information by changing the delivery location for the third package 118C from the third destination location point 112C (originally set) to the first destination location point 112A as requested by the third customer 120C. The circuitry 202 of the electronic control device 102 may be configured to update the order of handling the packages as the updated route information.

In FIG. 6, there is further shown a second table 612 which indicates the updated route information. In comparison to the first table 520, the second table 612 indicates the updated order of the plurality of destination location points 112A-112D to be visited by the vehicle 104 to handle the plurality of packages. As shown in the updated second table 612, for the third package 118C (with package reference number “3456”), the destination location point has been updated to the first destination location point 112A (“ABC”) from the third destination location point 112C (“WXY” indicated in FIG. 5). The updated first destination location point 112A (“ABC”) may indicate that the third package 118C (with package reference number “3456”) may be delivered to the third customer 120C (“Eve”) along with handling the package for the first customer 120A (“Alex”).

The circuitry 202 of the electronic control device 102 may be further configured to update the timing information based on the updated order of the plurality of destination location points 112A-112D in the route information. As shown in FIG. 6, the delivery/pick-up date and time 510 for the third package 118C has been updated from “1530 Hours” (shown in FIG. 5) to “1400 Hours”. This change in the timing information indicates the early handling of the package for the third customer 120C as requested. In some embodiments, the circuitry 202 of the electronic control device 102 may update the timing information for all other destination location points based on the updated order due to the request received from one customer. In other embodiments, the circuitry 202 of the electronic control device 102 may not update the timing information for all other destination location points based on the updated order so that other customers may not be affected because of the request made by one customer. For example, as shown in FIG. 6, the delivery/pick-up date and time 510 for the second customer 120B (“Anna”) has been updated (i.e. from 1430 Hours to 1500 Hours) because of the updated order and the priority of customer 514 set as “Low” for the second customer 120B (“Anna”). In another example, as shown in FIG. 6, the delivery/pick-up date and time 510 for the further customer 120D (“John”) has not been updated because of the priority of customer 514 set as “High” for the fourth customer 120D (“John”). In some embodiments, the circuitry 202 of the electronic control device 102 may update the order (i.e. on receipt of the request from one customer) based on the priority of customer 514 for other customers mentioned in the route information. For example, the priority of customer 514 for all other customers indicate “High”, then the circuitry 202 may only update the order and the timing information in case it's possible to deliver/pick up all the packages to other customers on set time.

In accordance with an embodiment, the user input received from the third customer 120C may correspond to change in the package handling instructions displayed on the GUI 408 of the third information processing apparatus 106C. For example, if the package handling instruction for the third package 118C indicates where exactly the package will be placed, and the third customer 120C enters that she “couldn't find the exact location” as the user input, then the circuitry 202 of the electronic control device 102 may be configured to consider such user input in the received request and update the route information by providing more detailed package handling instructions or update the order by changing the destination location point (as one of the plurality of destination location points of the route 112) for the third customer 120C.

The circuitry 202 of the electronic control device 102 may be further configured to transmit the updated route information to each of the plurality of information processing apparatuses 106 mentioned in the route information so that each customer is updated with the changed order of destination location points and the timing information. The circuitry 202 may be further configured to control the movement of the vehicle 104 based on the updated order of the plurality of destination location points 112A-112D in the route information so that each package should be handled as per the updated order and schedule without changing the route 112 originally set before receiving a customer request to change the delivery/pick-up location point.

In accordance with an embodiment, the circuitry 202 of the electronic control device 102 may be configured to receive multiple requests from a set of information processing apparatuses in the plurality of information processing apparatuses 106, before the route 112 to be travelled by the vehicle 104. The multiple requests may indicate different destination location points in the route 112 to handle multiple packages associated with multiple customers related to the set of information processing apparatuses. In such case, the circuitry 202 may be configured to analyze all the different destination location points included in the multiple requests and determine a common destination location point based on the analysis.

The common destination location point may be determined based on a distance between each of the destination location points. In some embodiments, the common destination location point may be one of the destination location points set in the route 112, so that vehicle 104 should not travel extra distance to reach the determined common destination location point. The circuitry 202 may be further configured to transmit information about the common destination location point and the updated timing information to the set of information processing apparatuses from which the multiple requests were received. The circuitry 202 may be further configured to receive acceptance information for the common destination location point from one or more of the set of information processing apparatuses. If the acceptance information indicates that the common destination location point is acceptable to the customers related to the one or more of the set of information processing apparatuses, the circuitry 202 may be assign an incentive value (for example monitory value, redeemable points, or discount points) for the customers associated with the one or more of the set of information processing apparatuses based on the acceptance information. The circuitry 202 may be further configured to transmit the assigned or calculated incentive value to the server 108 for future reference.

In accordance of an embodiment, the circuitry 202 of the electronic control device 102 of the vehicle 104 may receive multiple requests from one information processing apparatus associated with one customer. The multiple requests may be received within a predefined time frame or before the vehicle 104 reaches the destination location point associated with the information processing apparatus from where the multiple requests have been received. The multiple requests may indicate different destination location points indicated in the route information. For example, as shown in FIG. 6, the third customer 120C changes the destination location points multiple times before the vehicle 104 reaching the last updated destination location point. In such case, the circuitry 202 may count a number of the multiple requests received from the third information processing apparatus 106C and compare the count with a predefined threshold. The predefined threshold indicates a maximum number of times a customer may be allowed to change the delivery/pick-up location points. If the count exceeds or equals the predefined threshold (for example three), then the circuitry 202 may be configured to discard a last request in the multiple requests and may not update the order based on the last request.

In accordance with an embodiment, the functions performed by the circuitry 202 of the electronic control device 102 may be performed by the circuitry 302 of the server 108. In addition, the circuitry 302 may control the plurality of vehicles 310 shown in FIG. 3. The circuitry 302 may be configured to assign the plurality of routes to each of the plurality of vehicles 310. The circuitry 302 may analyze the number of packages to be handled, destination location point of each package, and current geo-location of each vehicle of the plurality of vehicles 310.

The circuitry 302 may be further configured to optimally assign different routes to different vehicles 310 based on the analysis. For example, the destination location points closest to the geo-location of a particular vehicle may be assigned to the same vehicle so that package handling may be faster at lower cost. In another example, the circuitry 302 of the server 108 may be configured to equally divide the number of packages among the plurality of vehicles 310.

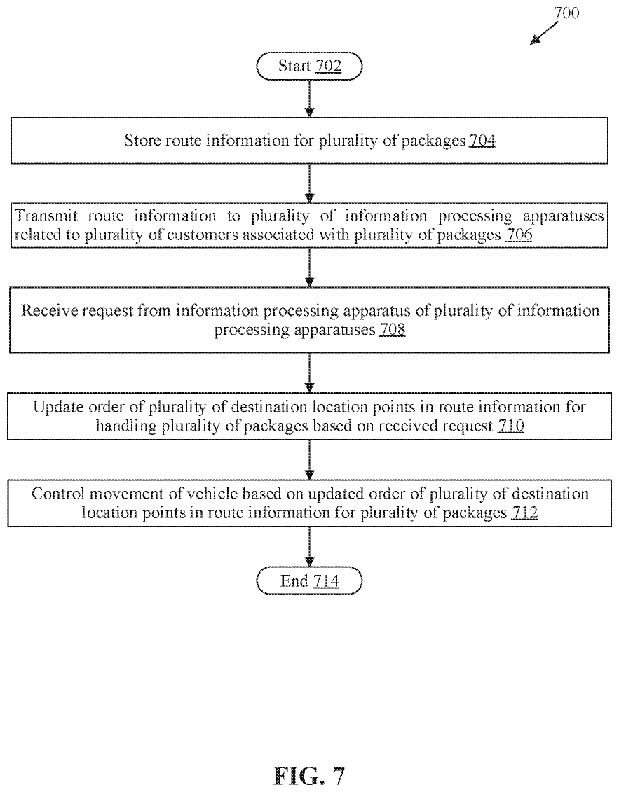

FIG. 7 depicts a flow chart that illustrates exemplary operations for an electronic control device to provide package handling assistance for a vehicle in accordance with an embodiment of the disclosure. With reference to 7, there is shown a flowchart 700. The operations from 702 to 712 may be implemented in the electronic control device 102. The operations of the flowchart 700 may start at 702 and proceed to 704.

At 704, route information for a plurality of packages may be stored. The circuitry 202 may be configured to receive the route information from the server 108 and store the received information in the memory 204 of the electronic control device 102. The stored route information may indicate a plurality of destination location points to be visited in an order, timing information associated with each of the plurality of destination location points, and package handling instructions for at least one of the plurality of packages at each of the plurality of destination location points.

At 706, route information may be transmitted to a plurality of information processing apparatuses 106 related to a plurality of customers 120A-120N associated with the plurality of packages 118. The circuitry 202 may be configured to transmit the route information to the plurality of information processing apparatuses 106 related to the plurality of customers 120A-120N associated with the plurality of packages 118.

At 708, a request may be received from an information processing device of the plurality of information processing apparatuses 106. The circuitry 202 may be configured to receive the request from the information processing apparatus. The request may indicate first destination location point from the plurality of destination location points 112A-112D for handling of a package associated with a customer which is related to the information processing apparatus. The request has been described in detail, for example, in FIG. 6.

At 710, the order of the plurality of destination location points in the route information may be updated for handling the plurality of packages based on the received request. The circuitry 202 may be configured to update the plurality of destination location points in the route information based on the received request. The circuitry 202 may be further configured to transmit updated order of plurality of destination location points in the route information to the plurality of information processing apparatuses 106. The process of updating the route information may be described in detail, for example in FIG. 6.

At 712, the movement of the vehicle 104 may be controlled based on the updated order of the plurality of destination location points 112A-112D in the route information for the plurality of packages 118. The circuitry 202 of the electronic control device 102 may be configured to control the movement of the vehicle 104 based on the updated order of the plurality of destination location points 112A-112D for the plurality of packages 118.

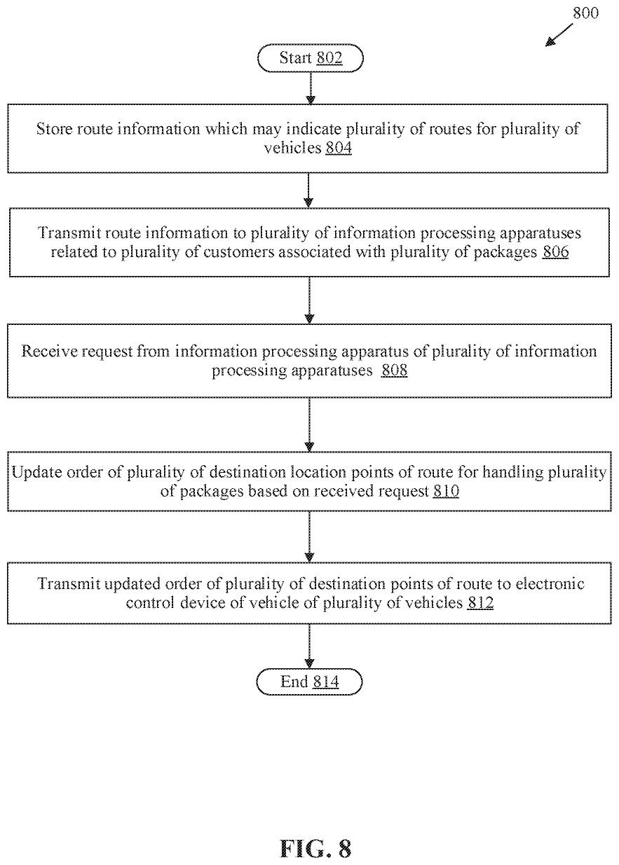

FIG. 8 depicts a flow chart that illustrates exemplary operations for a server to provide package handling assistance to vehicles in accordance with an embodiment of the disclosure. With reference to FIG. 8, there is shown a flowchart 800. The operations from 802 to 812 may be implemented in the server 108. The operations of the flowchart 800 may start at 802 and proceed to 804.

At 804, route information which may indicate a plurality of routes for a plurality of vehicles may be stored. The memory 304 of the server 108 may store the route information which may indicate a plurality of routes for a plurality of vehicles 310. Each of the plurality of routes may indicate a plurality of destination location points to be visited in an order for handling a plurality of packages, timing information associated with each of the plurality of destination location points, and package handling instructions for at least one of the plurality of packages at each of the plurality of destination location points.

At 806, the route information may be transmitted to a plurality of information processing apparatuses 106. The circuitry 302 of the server 108 may be configured to transmit, via the communication network 110, the stored route information to the plurality of information processing apparatuses 106 related to plurality of customers 120A-120N who are associated with plurality of packages 118.

At 808, a request may be received from a first information processing apparatus of the plurality of the information processing apparatuses 106. The circuitry 302 of the server 108 may be configured to receive the request from the information processing apparatus of the plurality of the information processing apparatuses 106. The request may indicate a first destination location point from the plurality of destination location points included in the route of the plurality of routes. Further, the received request is for handling a package associated with a customer which is related to the information processing apparatus.

At 810, the order of plurality of destination location points of the route may be updated for handling the plurality of packages 118 based on the received request. The circuitry 302 of the server 108 may be configured to update the plurality of destination location points in the route information of the route based on the received request. The process of updating the route information may be described in detail, for example in FIG. 6.

At 812, the updated order of plurality of destination location points of the route may be transmitted to the electronic control device 102 of the vehicle 104 of the plurality of vehicles 310. The circuitry 302 of the server 108 may be configured to transmit the updated order of the destination location points of the route to the electronic control device 102 of the vehicle 104 of the plurality of vehicles 310, via the communication network 110. Control passes to end.

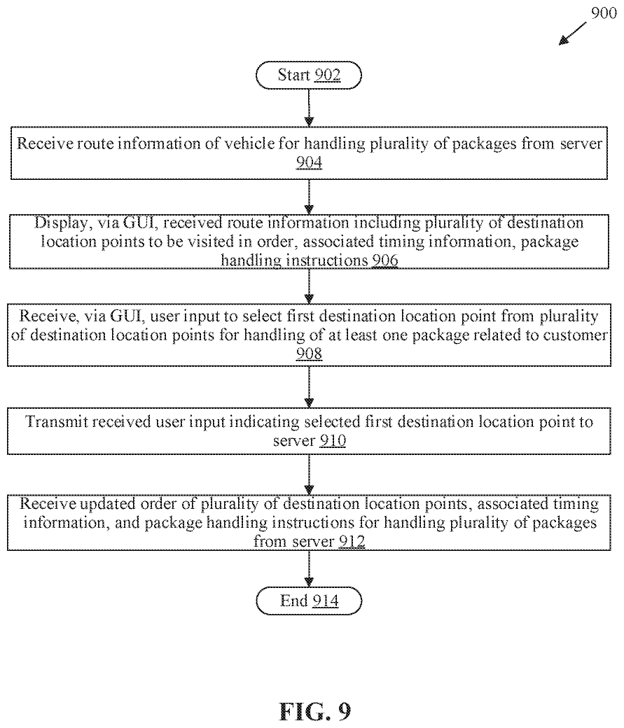

FIG. 9 depicts a flow chart that illustrates exemplary operations for an information processing apparatus to receive package handling assistance from a server in accordance with an embodiment of the disclosure. With reference to FIG. 9, there is shown a flowchart 900. The operations from 902 to 914 may be implemented in one of the information processing apparatuses shown in FIGS. 1 and 4. The operations of the flowchart 900 may start at 902 and proceed to 904.

At 904, the route information of vehicle 104 for handling a plurality of packages 118 may be received from the server 108. The circuitry 402 of the information processing apparatus (for example the first information processing apparatus 106A) may be configured to receive the route information of the vehicle 104 for handling the plurality of packages 118. The circuitry 402 of the first information processing apparatus 106A may receive the route information from the server 108 via the communication network 110. The route information may include a plurality of destination location points to be visited in an order by the vehicle 104, timing information associated with each of the plurality of destination location points and package handling instructions for at least one of the plurality of packages at each of the plurality of destination location points. The plurality of packages may include at least one package related to a customer (for example the first customer 120A) associated with the first information processing apparatus 106A.

At 906, the received route information including the plurality of destination location points to be visited in the order, associated timing information, and the package handling instructions may be displayed, via the GUI. The circuitry 402 of the first information processing apparatus 106A may be configured to display the route information, via the GUI 408, of the display screen 406A as shown in FIG. 6.

At 908, a user input, via the GUI, may be received to select a first destination location point from the plurality of destination location points for handling of the at least one package associated with the first customer 120A. The circuitry 402 of the first information processing apparatus 106A may be configured to receive the user input to select the first destination location point from the plurality of destination location points for handling of the at least one package associated with the first customer 120A as described in detail, for example, in FIG. 6.

At 910, the received user input indicating the selected first destination location point may be transmitted to the server 108. The circuitry 402 of the first information processing apparatus 106A may be configured to transmit the received user input indicating the selected first destination location point to the server 108, via the communication network. The circuitry 302 of the server 108 may be configured to update the plurality of destination location points in the route information of the route based on the received user input.

At 912, updated order of the plurality of destination location points, associated timing information, and the package handling instructions for handling the plurality of packages 118 may be received from the server 108. The circuitry 402 of the first information processing apparatus 106A may be configured to receive the updated order of the plurality of destination location points, the associated timing information, and the package handling instructions from the server, via the communication network 110. Control passes to end.

Various embodiments of the disclosure may provide a non-transitory, computer-readable medium and/or storage medium, and/or a non-transitory machine readable medium and/or storage medium stored thereon, a set of instructions executable by a machine and/or a computer providing package handling assistance for a vehicle. The set of instructions may be executable by the machine and/or the computer to perform the steps that may include transmission of route information to a plurality of information processing apparatuses related to a plurality of customers associated with a plurality of packages. The route information may include a plurality of destination location points to be visited in an order by the vehicle, timing information associated with each of the plurality of destination location points, and package handling instructions for at least one of the plurality of packages at each of the plurality of destination location points. A request may be received from an information processing apparatus of the plurality of information processing apparatuses. The request may indicate a first destination location point from the plurality of destination location points for handling a package associated with a customer which is related to the information processing apparatus. The order of the plurality of destination location points may be updated based on the received request. The movement of the vehicle may be controlled based on the updated order of the plurality of destination location points in the route information for the plurality of packages.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

What is claimed is:

1. An electronic control device to provide package handling assistance for a vehicle, comprising:
a memory configured to store route information for each of a plurality of packages, wherein the route information includes a plurality of destination location points to be visited in an order by the vehicle, timing information associated with each of the plurality of destination location points, and package handling instructions for at least one of the plurality of packages at each of the plurality of destination location points; and
circuitry, coupled with the memory, configured to:
transmit the route information to a plurality of information processing apparatuses related to a plurality of customers associated with the plurality of packages;
receive a request from an information processing apparatus of the plurality of information processing apparatuses, wherein the request indicates a first destination location point from the plurality of destination location points for handling a package associated with a customer which is related to the information processing apparatus;
update the order of the plurality of destination location points in the route information for handling the plurality of packages based on the received request; and
control the movement of the vehicle based on the updated order of the plurality of destination location points in the route information for the plurality of packages.

2. The electronic control device according to claim 1, wherein the plurality of destination location points are geo-locations where the corresponding plurality of packages are to be handled.

3. The electronic control device according to claim 1, wherein the route information indicates a second destination location point from the plurality of destination location points, and wherein the second destination location point is a geo-location at which the package related to the information processing apparatus has to be originally handled before update in the order.

4. The electronic control device according to claim 3, wherein the first destination location point in the received request is earlier than the second destination location point.

5. The electronic control device according to claim 3, wherein the first destination location point in the received request is later than the second destination location point.

6. The electronic control device according to claim 1, wherein the circuitry is further configured to:
update the timing information associated with each of the plurality of destination location points based on the updated order of the plurality of destination location points in the route information; and
transmit the route information including the updated order of the plurality of destination location points and the updated timing information to the plurality of information processing apparatuses.

7. The electronic control device according to claim 1,
wherein the information processing apparatus:
renders, through a graphical user interface (GUI), the plurality of destination location points to be visited in the order, the timing information, and the package handling instructions;
receives, through the GUI, a user input to select the first destination location point from the rendered plurality of destination location points; and
transmits, to the electronic control device, the request which indicates the selected first destination location point.

8. The electronic control device according to claim 1, wherein the circuitry is further configured to:
receive information which indicates a new destination location point from the information processing apparatus, wherein the new destination location point is different from each of the plurality of destination location points in the route information; and
select the first destination location point from the plurality of destination location points, where a distance between the first destination location point and the new destination location point is within a predefined threshold distance.

9. The electronic control device according to claim 1, wherein the circuitry is further configured to receive the route information from a server.

10. The electronic control device according to claim 1, wherein the circuitry is further configured to:
authenticate the information processing apparatus related to the customer at the first destination location point; and
control the vehicle to handle the package with the customer based on the authentication.

11. The electronic control device according to claim 1,
wherein the route information comprises priority information for handling of at least one of plurality of packages; and
wherein the circuitry is further configured to update the order of the plurality of destination location points in the route information and the timing information based on the priority information.

12. The electronic control device according to claim 1, wherein the circuitry is further configured to:
receive multiple requests from a set of information processing apparatuses of the plurality of information processing apparatuses, wherein the multiple requests include different first destination location points for handling of packages associated with customers which are related to the set of information processing apparatuses;
determine a common destination location point from the plurality of destination location points based on distances between different first destination location points included in the multiple request; and
transmit information about the determined common destination location point, the associated timing information, and the package handling instructions to the set of information processing apparatuses.

13. The electronic control device according to claim 12, wherein the circuitry is further configured to:
receive acceptance information for the common destination location point and the associated timing information from the set of information processing apparatuses;
assign an incentive value to the set of information processing apparatuses based on the received acceptance information; and
transmit the incentive value for the set of information processing apparatuses to a server.

14. The electronic control device according to claim 1, wherein the circuitry is further configured to:
receive multiple requests, within a time frame, from the information processing apparatus, wherein the multiple request include different first destination location points of the plurality of destination location points; and
discard a last request in the multiple requests in case a number of multiple requests received within the time frame exceeds a predefined threshold.

15. A server to provide package handling assistance to vehicles, comprising:
a memory configured to store route information which indicates a plurality of routes for a plurality of vehicles, wherein each of the plurality of routes indicates a plurality of destination location points to be visited in an order for handling a plurality of packages, timing information associated with each of the plurality of destination location points, and package handling instructions for at least one of the plurality of packages at each of the plurality of destination location points;
circuitry, coupled to the memory, configured to:
transmit the stored route information to a plurality of information processing apparatuses related to a plurality of customers associated with the plurality of packages for each route;
receive a request from an information processing apparatus of the plurality of information processing apparatuses, wherein the request indicates a first destination location point from the plurality of destination location points included in a route of the plurality of routes, and wherein the received request is for handling a package associated with a customer which is related to the information processing apparatus;
update an order of the plurality of destination location points of the route for handling the plurality of packages based on the received request; and
transmit the updated order of the plurality of destination location points of the route to an electronic control device of a vehicle of the plurality of vehicles.

16. The server according to claim 15, wherein the circuitry is configured to:
update the timing information associated with each of the plurality of destination location points of the route based on the updated order of the plurality of destination location points; and
transmit the updated timing information to the electronic control device of the vehicle.

17. The server according to claim 15, wherein the circuitry is further configured to select the vehicle from the plurality of vehicles based on a geo-location of the vehicle and geo-locations of the plurality of destination location points of the route for handling of the plurality of packages for the route.

18. The server according to claim 15, wherein the circuitry is further configured to:
analyze a number of the plurality of destination location points and a number of the plurality of packages for the plurality of routes; and
assign a set of destination location points of the plurality of destination location points and a set of packages of the plurality of packages to each vehicle based on the analysis.

19. An information processing apparatus, comprising:
a display screen configured to display a graphical user interface (GUI); and
circuitry, coupled with the display screen, configured to:
receive, from a server, route information of a vehicle for handling a plurality of packages,
where the route information includes a plurality of destination location points to be visited in an order, timing information associated with each of the plurality of destination location points, and package handling instructions for at least one of the plurality of packages at each of the plurality of destination location points, and
wherein the plurality of packages include at least one package related to a customer associated with the information processing apparatus;
display, via the GUI, the received route information including the plurality of destination location points to be visited in the order, the associated timing information, and the package handling instructions;
receive, via the GUI, a user input to select a first destination location point from the plurality of destination location points for handling the at least one package related to the customer;
transmit the received user input indicating the selected first destination location point to the server; and
receive an updated order of the plurality of destination location points, the associated timing information, and the package handling instructions for handling the plurality of packages from the server.

20. The information processing apparatuses according to claim 19, wherein the circuitry is further configured to:
receive current geo-location of the vehicle from an electronic control device of the vehicle; and
display the received current geo-location of the vehicle on the display screen.
